(19) United States
(12) Patent Application Publication
(10) Pub. No.: US 2014/0042963 A1
(43) Pub. Date: Feb. 13, 2014

(54) ELECTROMAGNETIC INDUCTION DEVICE OF MAGNETIC BAR FOR CHARGING AND SUPPLYING POWER

(71) Applicant: Shaoming Yu, Dongguan (CN)

(72) Inventor: Shaoming Yu, Dongguan (CN)

(73) Assignee: DONGGUAN JIE DU ELECTRONICS TECHNOLOGY CO., LTD., Dongguan, Guangdong (CN)

(21) Appl. No.: 14/111,764

(22) PCT Filed: Mar. 6, 2012
(86) PCT No.: PCT/CN2012/071961

§ 371 Date: Oct. 14, 2013

(30) Foreign Application Priority Data
Jan. 6, 2012 (CN) 201220003553.9

(51) Int. Cl. H02J 7/02

(52) U.S. Cl. CPC H02J 7/025
USPC 320/108

(57) ABSTRACT

A Magnetic bar shaped electromagnetic induction charging electric device. The device comprises a power body (1) and a charging body (2), which are separated; the power body (1) comprises a first shell (11), a first charging circuit board (12) fixed in the first shell (11), a chargeable battery(13), a load (14) and a first small magnetic bar (15) with a coil at the periphery, and the first small magnetic bar is connected with the first charging circuit board (12); A load (14) of the embodiment is a LED light, which can be the load for others; The charging body (2) comprises a second shell (21), a second charging circuit board (22) fixed in the second shell (21), a second small magnetic bar (23) with a coil at the periphery, and the second small magnetic bar (23) is connected with the second charging circuit board (22) and a charging plug (24) installed in the second shell (21); A clamping part (211) for clamping the outside of the first shell (11) is formed on the second shell (21). The device can supply power to a battery of an electrical apparatus by means of non-contact manner.

### FIELD OF THE INVENTION

The present invention relates to technical field of electrical and electronic device, more particularly an electromagnetic induction device of magnetic bar for charging and supplying power.

### BACKGROUND OF THE INVENTION

The structure of small electrical appliances such as flashlight and electrical shaver usually were designed for chargeable. In general, there are two methods of charging: through the power line, or directly by charging plug installed in electrical appliances. The former one that the voltage-transforming device needs to be installed in the front end of plug is a larger size and more copper wires for use, and the same situation as the latter. It not only increases the size, but also needs to consume more copper wires, to sum up, the current chargeable electronic device's size are larger and the costs are higher.

### SUMMARY OF THE PRESENT INVENTION

The purpose of present invention is to provide an electromagnetic induction device of magnetic bar for charging and supplying power.

The technical method of an electromagnetic induction device of magnetic bar for charging and supplying power. The device comprises a power body and a charging body, which are separated. The power body comprises a first shell, a first charging circuit board fixed in the first shell, a chargeable battery, a load and a first small magnetic bar with a coil at the periphery, and the first small magnetic bar is connected with the first charging circuit board. The charging body comprises a second shell and a second charging circuit board fixed in the second shell, a second small magnetic bar and a charging plug fixed on the second shell. The second small magnetic bar is connected with the second charging circuit board, and a coil is attached to the periphery of the second small magnetic bar. a clamping part for clamping the outside of the first shell is formed on the second shell.

The charging plug of the charging body is fixed in the second shell by passing through a rotator, which is to say that a round slide forming in the second shell can be rotated in the rotator.

The invention is used of small magnetic bar with a coil to supply power for the battery of electrical device by means of the electromagnetic induction, which can decrease the size of the coil used for charging, furthermore, the device becomes smaller in size and decreases consumption in copper wire as well as the cost.

### DESCRIPTION OF DRAWING

FIG. 1 is an Exploded View Diagram of an embodiment of the power body according to the present invention.

FIG. 2 is an Exploded View Diagram of an embodiment of the charging body according to the present invention.

FIG. 3 is a Schematic View showing an embodiment of the FIG. 1 in combination with FIG. 2 according to the present invention.

FIG. 4 is a Function Block Diagram of the present invention.

### DETAILED DESCRIPTION OF THE PRESENT INVENTION

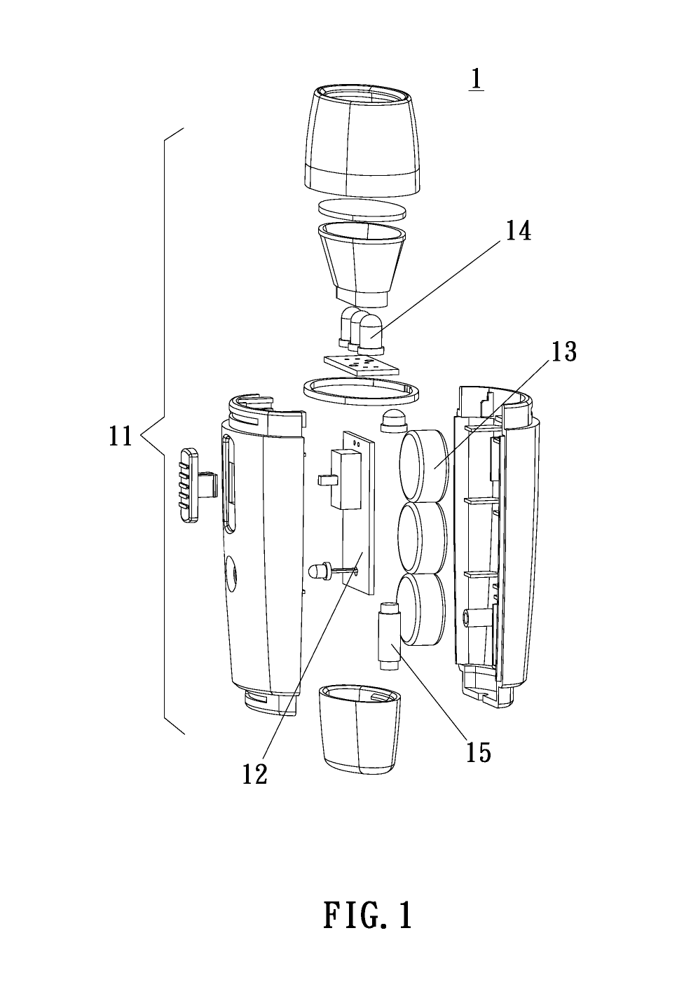

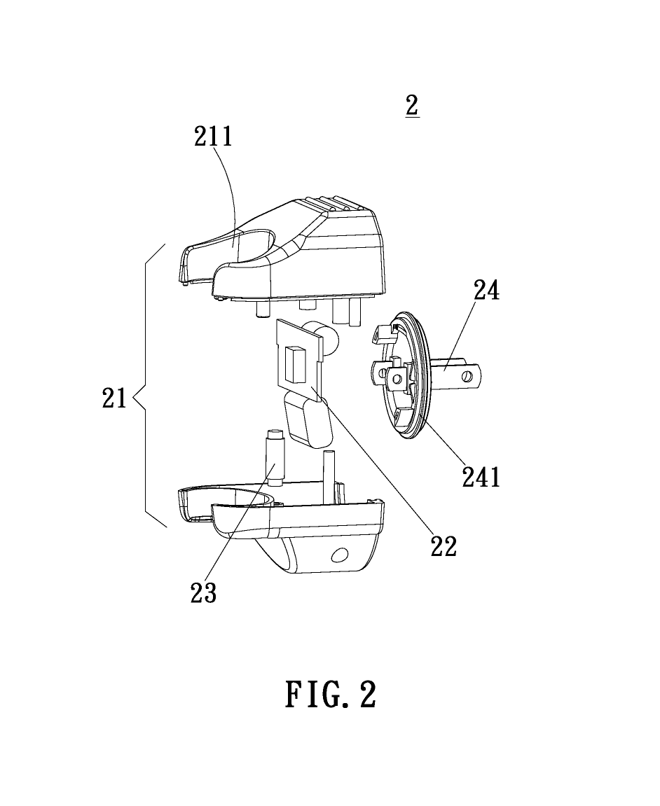

Referring to FIG. 1-2, an electromagnetic induction device of magnetic bar for charging and supplying power, characterized in that: comprises a power body (1) and a charging body (2), which are separated; the power body (1) comprises a first shell (11), a first charging circuit board (12) fixed in the first shell (11), a chargeable battery (13), a load (14) and a first small magnetic bar (15) with a coil at the periphery, and the first small magnetic bar is connected with the first charging circuit board (12); A load (14) of the embodiment is a LED light, which can be the load for others; The charging body (2) comprises a second shell (21) and a second charging circuit board (22) fixed in the second shell (21), a second small magnetic bar (23) and a charging plug (24) fixed on the second shell (21); The second small magnetic bar is connected with the second charging circuit board, and a coil is attached to the periphery of the second small magnetic bar (23); A clamping part (211) for clamping the outside of the first shell (11) is formed on the second shell (21).

The charging plug (24) of the charging body (2) is fixed in the second shell by passing through a rotator (241), which is to say that a round slide (212) forming in the second shell can be rotated in the rotator; The charging plug (24) is rotatable so it is easy to utilize, let the power body (1) is to prevent interference from other plug.

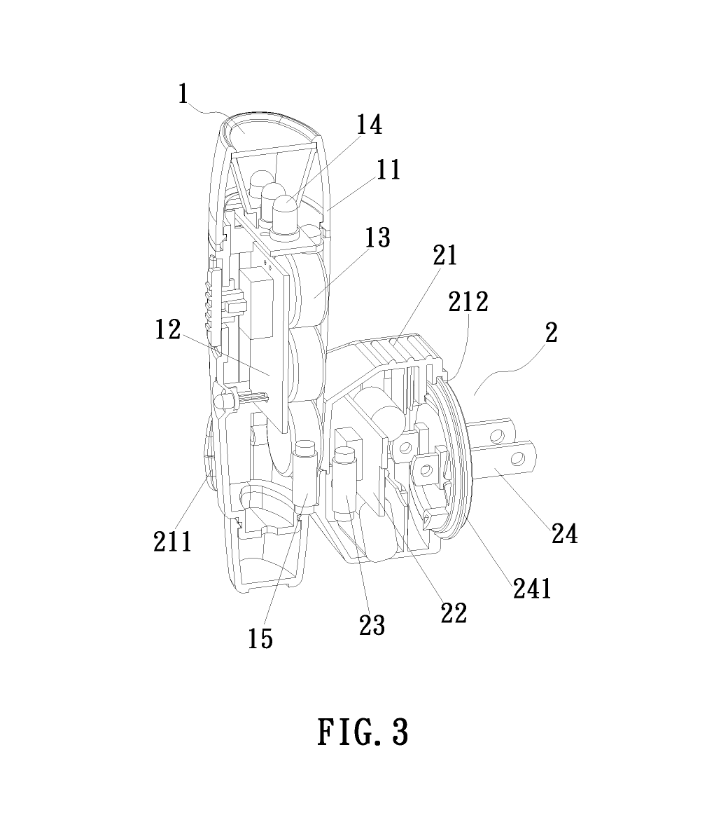

As shown in FIG. 3 a second small magnetic bar (23) was located near a clamping part (211), the first small magnetic bar (15) was located near the connection part, where is inside of the first shell (11), so when the charging body (2) was clamped on the outside of the power body (1), both the first small magnetic bar (15) and the second magnetic bar (23) are closed to each other; when the charging plug (24) was electrically connected, the second charging circuit board (22) of the charging body (2) generate electricity, and the induced current was produced by the electric current flowing past to a coil at the periphery of the second small magnetic bar (23) and then by utilizing electromagnetic induction to a coil at the periphery of the first small magnetic bar (15) of the charging body (1), furthermore, the power was supplied to rechargeable battery and then to the load (14) through the first charging circuit board (12). Therefore, the present invention is to supply power to the battery of electrical appliances by a coil of the small magnetic bar through electromagnetic induction, which can decrease the size of the coil used for charging, furthermore, the device becomes smaller in size and decreases consumption in copper wire as well as the cost.

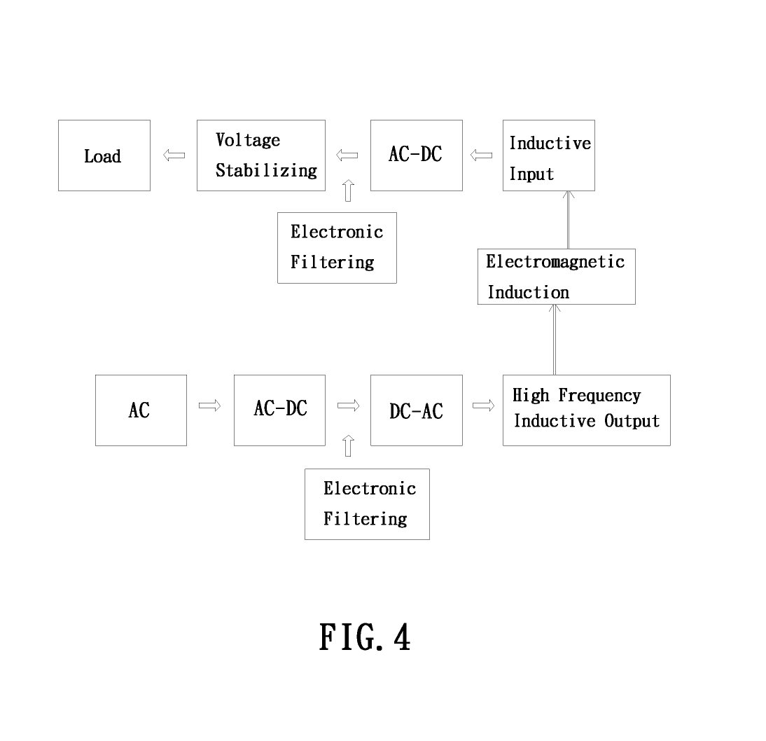

As shown in FIG. 4 the electric circuit as a charging output of the second charging circuit board (22) was used in output circuit of high frequency induction, improved the frequency of the output, and the first charging circuit board (12) as a charging input was used in resonance absorption for implementing electromagnetic induction charging function in the present invention.

The power body (1) and the charging body (2) are the separate structure, which are easy to clamp and remove while not charging. It does not affect the power body (1) in use.

As shown in drawings is an embodiment of the present invention, the said load of the present invention can also be a small machine, or a light etc. thereby constituting an electric fan, an electric razor, desk lamp, headlight and variety of electrical appliance.

With respect to the present invention details of a switch, an indicator and a fixed load in the power body (1) need not be given here.

To sum up, the present invention that is smaller and cheaper can be variety of small or tiny electromagnetic induction charging products or devices.

What is claimed is:

1. An electromagnetic induction device of magnetic bar for charging and supplying power, is characterized in that: comprises a power body (1) and a charging body (2), which are separated; wherein the power body (1) comprises a first shell (11), a first charging circuit board (12) fixed in the first shell (11), a chargeable battery (13), a load (14) and a first small magnetic bar (15) with a coil at the periphery, and the first small magnetic bar is connected with the first charging circuit board (12); A load (14) of the embodiment is a LED light, which can be the load for others; The charging body (2) comprises a second shell (21), a second charging circuit board (22) fixed in the second shell (21), a second small magnetic bar (23) with a coil at the periphery, and the second small magnetic bar (23) is connected with the second charging circuit board (22) and a charging plug (24) installed in the second shell (21); A clamping part (211) for clamping the outside of the first shell (11) is formed on the second shell (21).

2. The electromagnetic induction device of magnetic bar for charging and supplying power as set forth in claim 1, is characterized in that: The charging plug (24) of the charging body (2) is installed in the second shell by passing through a rotator (241), which is to say that a round slide (212) forming in the second shell can be rotated in the rotator (241).
